(19) United States
(12) Patent Application Publication
(10) Pub. No.: US 2009/0055251 A1
(43) Pub. Date: Feb. 26, 2009

(54) DIRECTED ONLINE ADVERTISING SYSTEM AND METHOD

(75) Inventors: Ketan K. Shah, Fremont, CA (US); Jianping Zhu, Burnaby (CA); Padmanabh Y. Deshmukh, Fremont, CA (US)

Correspondence Address: FITCH EVEN TABIN AND FLANNERY, 120 SOUTH LA SALLE STREET, SUITE 1600, CHICAGO, IL, 60603-3406, US

(73) Assignee: WEBLISTIC, INC., A CALIFORNIA CORPORATION, Fremont, CA (US)

(21) Appl. No.: 11/841,770

(22) Filed: Aug. 20, 2007

(51) Int. Cl. G06Q 30/00

(52) U.S. Cl. 705/14

(57) ABSTRACT

A system is provided for managing a sales person. An automating server is configured to automate management of sales activities of the sales person selling an electronic advertisement product. A categorizing module is coupled to the automating server. The categorizing module is configured to define a category for businesses located within a targeted geographical area. A territory creation module is coupled to the automating server. The territory creator is configured to define a sales territory within the targeted geographical area for the sales person. The automating server is further configured to create the electronic advertisement product for the business based on the category and the sales territory. The automating server is further configured to generate leads for the sales person to sell the electronic advertisement product to the business within the sales territory.

### FIELD OF THE APPLICATION

The present invention relates generally to a system and method for providing online advertising based on territory-specific criteria.

### BACKGROUND

Internet-based advertising is becoming more and more important in today's business world. Many companies advertise their products online. Some advertisers pay to place their advertisements on popular websites, such as Yahoo.com, NYTimes.com or Google.com. Such advertisements are often in the form of a banner advertisement on the website, i.e., a little section on the website where the advertisement is shown. The banner advertisement may be a primarily graphical advertisement such as an image of the product being advertised. Other types of advertisements include textual advertisements that do not contain images; instead, they solely contain text and typically include a link to a website for the item being advertised.

Displaying such advertisements to all people visiting a website does not always result in a lot of sales or clicks on the advertisements. For example, an advertisement for a department store that is not located anywhere near where a user accessing the website lives is generally not going to interest the user. In an effort to improve the level of interest in displayed advertisements, some websites display advertisements that are in some way related to the content of the material on the website. For example, in the event that advertisements are included on a blog discussing the stock market and personal finance, the advertisements displayed have some relationship to the stock market or personal finance. Google Adsense™ and Yahoo's Publisher Network™ both provide advertisements to a set of websites, and the advertisements are provided based on the content of the website, to ensure that the advertisements are relevant and most likely to be of interest to a person visiting the websites.

### SUMMARY

At least one embodiment of the invention is directed to a method of managing a sales person. Automating management of sales activities of the sales person selling an electronic advertisement product is provided. A category for a business within a targeted geographical area is defined. A sales territory within the targeted geographical area is also defined. The electronic advertisement product for the business is created based on the category and the sales territory. A lead is generated for the sales person to sell the electronic advertisement product to the business within the sales territory.

At least one embodiment of the invention is directed to a system for managing a sales person. An automating server is configured to automate management of sales activities of the sales person selling an electronic advertisement product. A categorizing module is coupled to the automating server. The categorizing module is configured to define a category for businesses located within a targeted geographical area. A territory creation module is coupled to the automating server. The territory creator is configured to define a sales territory within the targeted geographical area for the sales person. The automating server is further configured to create the electronic advertisement product for the business based on the category and the sales territory. The automating server is further configured to generate leads for the sales person to sell the electronic advertisement product to the business within the sales territory.

The system and method may be embodied as an automated end to end system or method for providing locally targeted advertisements through multiple distribution channels. An end to end embodiment may also provide for continuous performance monitoring and adjustments to advertisements and advertisement distribution channels. Advertisements may be bundled in groups of related advertisements according to campaign goals. Bundled advertisements may feature individual advertisements with varying degrees of exposure for example the individual advertisements may have different sized layouts, distinctive coloring, motifs, bold font or underlining. Bundled advertisements as well as individual advertisements may be analyzed as candidates for any form of online advertisements placed on a variety of distribution channels. Exposure levels for the advertisements on the distribution channels may also be analyzed. Specific channels and exposure levels may be selected based on campaign goals, performance goals, expected return on investment, demographic audience, historic data, behavioral analytics or any other historic, real time or predictive metrics. Proactive performance monitoring, price adjustments, re-bundling and distribution channel selection may also be featured.

The above summary of the present invention is not intended to represent each embodiment or every aspect of the present invention. The detailed description and Figures will describe many of the embodiments and aspects of the present invention.

### BRIEF DESCRIPTION OF THE DRAWINGS

The above and other aspects, features and advantages of the present embodiments will be more apparent from the following more particular description thereof, presented in conjunction with the following drawings wherein:

FIG. 1 illustrates a method of implementing an online advertising franchise platform according to an embodiment of the invention;

FIG. 2 illustrates a system for implementing an online advertising franchise platform according to an embodiment of the invention;

FIG. 3 illustrates a logistic platform according to an embodiment of the invention;

FIG. 4 illustrates a territory creation display screen shown on the user interface according to an embodiment of the invention;

FIG. 5 illustrates a sales campaign and leads display screen shown on the user interface according to an embodiment of the invention;

FIG. 6 illustrates a method of grouping similar advertisers according to an embodiment of the invention; and

FIG. 7 illustrates an advertising management system according to an embodiment of the invention.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

Embodiments of the invention are directed to a complete local online advertising franchise platform. The local online advertising franchise platform is utilized to manage the selling of online advertising products, such as various online advertising packages of banner video and/or text advertisements. The platform determines a target geographical area and relevant business categories for a salesperson to pitch/offer the various online advertising products to various businesses with advertising needs.

A plurality of salespeople sells the online/electronic advertising to various businesses within target geographical areas. The online/electronic advertising may consist of an advertising package, i.e., a set of online advertising guaranteed to be of a predefined format, such as banner, textual block, or video advertisements. The advertisements may be placed on a website, such as Google.com or NYTimes.com, or on any other website selling advertising space.

The salespeople sell advertising with an online advertising company such as Google Adsense™, Yahoo Publisher Network™, or some other advertising entity that places advertisements on websites. The online advertising franchise platform serves as an intermediary between the businesses/advertising customers and the online advertising company to ensure that the businesses' specific advertising needs are met. The online advertising franchise platform analyzes statistics about the territory and types of businesses located within the territory and generate “leads,” i.e., the names of businesses to approach in an effort to sell an advertising product. The approach discussed herein is a systematic approach to selling and managing electronic advertising in a defined geographical area.

The term “local” as used herein should be appreciated to mean any type of definable geographical territory or area. According to the online advertising franchise platform, geographical territories are defined for salespeople who are to sell online advertising to various companies desiring to advertise their products and/or services.

A certain territory is created based on “local factors” such as local business demographics, categories and historical marketing data. A sales territory may be defined based on estimated revenue generation potential produced by the territory. Historical marketing data may also be used in determining the territory. The territory may be an area having, for example, about 50,000 businesses in various industries to ensure a good balance of different categories. Alternatively, for example, the territory could be defined based on the total number of certain types of professionals, such as the total number of lawyers, the total number of dentists, and so forth.

The teachings discussed herein provide a complete and end-to-end platform for local online advertising industry that is driven off of “local factors” and “performance factors.” The platform takes into account the local factors such as a local sales force, local business categories, local historical marketing data, local online channels, and local demographics. The platform also takes into account performance factors such as historical performance of sales teams and advertisers, real time performance of each advertiser on each channel, and performance expectations in each local business category.

The complete local online advertising franchise platform allows for territory creation based on local factors such as local business demographic, categories and historical marketing data. The platform also provides territory-based automation of local sales teams. Lead generation and sales campaign management is generated based on local business categories and historical local marketing data. Configurable product creation and association is generated based on business categories as well as return on investment (“ROI”) and distribution channels. Automatic creation of customer tracking web material and advertisement copies is further provided based on local business categories. The platform also provides for automation of production and fulfillment of various advertising campaigns on various distribution channels. A pool of advertisers with similar criteria may be grouped together for better returns on investment while giving them individual exposure based on their budget and performance expectations. For example, several different dentists within an area, such as Beverly Hills, Calif., may be grouped together and collectively advertised as “dentists.” In such embodiment, an advertisement for dentists on the Beverly Hills area is displayed on a website. In the event that the user clicks on the advertisement, the user is directed to another website listing several dentists in Beverly Hills with varying degrees of exposure on the web page. This way, the cost of the advertisement is spread out among a pool of dentists, as opposed to listing one particular dentist on the initial advertisement.

The online advertising franchise platform provides for automated price adjustment based on local business criteria and performance calculations. It also provides for automated, real time media distribution adjustment on various channels based on real time performance calculations. Configurable and real time adjustment in advertiser exposure on each channel are based on performance calculations and expectations. Proactive performance monitoring, alert mechanism and adjustment (for advertisers) is provided based on expected results. The platform further manages various channels and monitors and analyzes franchisees (i.e., individual local sales teams) based on performance expectation and calculations.

The platform allows cohesive integration of various data points of hundreds of local business categories and uses them to create effective marketing campaign for a local business. The platform also automates and monitors functions of local sales force. The platform further provides ways to distribute, control and monitor advertisers exposure on various online channels. The platform also facilitates effective grouping of advertisers with similar goals and advertising criteria for giving them best possible return on their investment. The platform allows for the easy expansion of local sales forces through a franchise model.

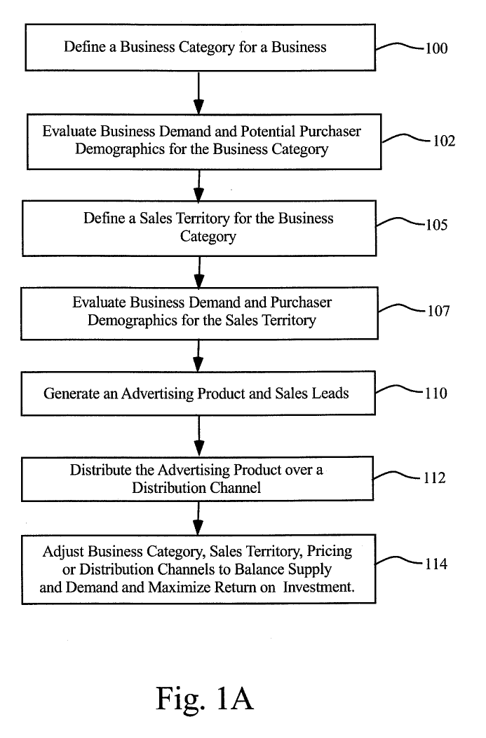

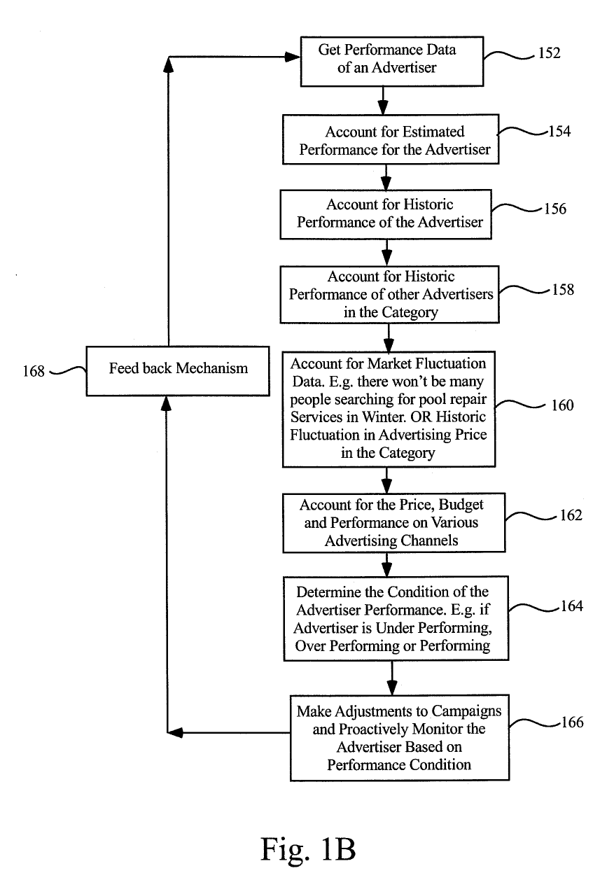

FIG. 1 illustrates a method of implementing an online advertising franchise platform according to an embodiment of the invention. FIG. 1A illustrates the steps for generating and distributing an advertising product. FIG. 1B illustrates the steps to continually refine and optimize the distribution of advertising products.

In FIG. 1A, First, at operation 100, a category is defined for a local business. The category may be a broad, such as “automotive,” or “retailing.” Alternatively, the category may be more specific, such as “discount retailer,” or “luxury automobiles.” The category may be determined based on an analysis of statistics of businesses located within a certain geographical area, such as a large metropolitan area.

The business category may be further evaluated to determine the business demand and potential purchase demographics 102. This information may be used to partition the business category by geographic location or to determine local geographic areas with a critical mass of demand and potential purchasers that may be targeted as part of for a marketing campaign. Next, a local sales territory is defined at operation 105. The local sales territory may be based on a zip code, or set of zip codes. Alternatively, or additionally, the local sales territory may be based on an area of a city or a set of towns adjacent to each other. In a geographically large city, such as Los Angeles, Calif., the city may be divided into several local sales territories.

The sales territory may be evaluated to determine the business demand and purchaser demographics specific to the sales territory 107. Next, at operation 110, an electronic advertisement product is created for the local business based on the category and local sales territory. The electronic advertisement product is an advertisement package that will be offered to various businesses within the category. The electronic advertisement product may comprise a set of online text or banner advertisements on various websites. The electronic advertisement product is determined based on the type of advertisement products that similar businesses have purchased. A lead is generated for a sales person to sell the electronic advertising product to a local business within the local sales territory. The lead is based on the identities of specific businesses determined to have advertising needs within the local sales territory.

The advertising product may be distributed over one or more distribution channels 112. The advertising product may be distributed with varying degrees of exposure. The distribution channels may also be monitored for performance. The business category, sales territory, pricing or distribution channels may be adjusted to balance supply and demand or to maximize return on investment 114.

In FIG. 1B, steps to refine and optimize advertisement distribution are shown. Performance data for an advertiser can be acquired 152. The performance data may include, for example, the response rate to a particular advertisement, the response rate to a group of advertisements in a category or the response rate to a group of advertisements in a territory. The performance data may also include indicia of performance from database records, customer survey information or any other source having information relative to the performance of the advertiser.

The advertiser's performance may then be systematically analyzed by comparing the advertiser's performance with and accounting for; the estimated performance of the advertiser 154, the historic performance of the advertiser 156, historic performance of other advertisers in the category 158, the historic performance of other advertisers in the category 158, market fluctuation data 160, price budget and performance on various advertising channels 162, and the condition of the advertisers performance 164.

Adjustments to campaigns and pro-active monitoring of the advertiser 166 may be accomplished. A feedback mechanism 168 allows performance data be used for fine tuning the advertisement distribution optimizing the distribution of advertisements to advertisers.

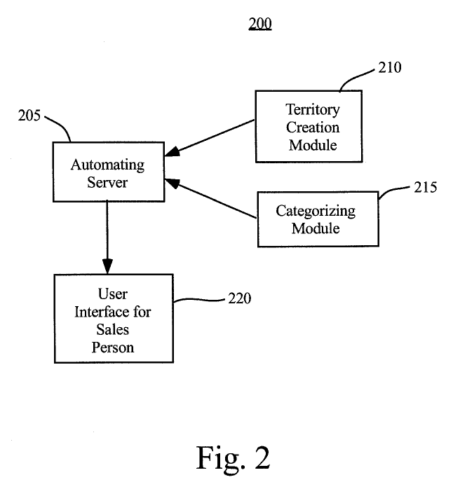

FIG. 2 illustrates a system 200 for implementing an online advertising franchise platform according to an embodiment of the invention. An automating server 205 performs various calculations and interfaces with a territory creation module 210 that creates a territory for sales to be made. The territory may be based on specific sales goals of the goods or services to be marketed or the composition of the business category. Once the territory has been defined based on predefined criteria, revenue potential for the geographical territory is verified.

A categorizing module 215 determines which types of businesses within the territory to target for sale of an advertising product. The automatic server 205 forwards this information to a user interface 220 for a sales person. The user interface 220 displays the territory and categories for the sales person to attempt to make a sale of the advertising product.

After the various geographical territories in which to sell advertising products have been determined, the system determines what types of businesses should be targeted and decides which zip codes, cities or towns, and/or portions of cities or towns need to be covered.

Next, the scope of the advertisements for each territory is determined. There are several decisions to be made in determining the scope of the advertisements. A market for advertising may be determined by analyzing the geographical territory and deriving the market by grouping certain cities, areas of cities, or zip codes based on certain user's behavior and other available geographical (demographic) information.

Each city is analyzed based on known user/consumer behavior, not just on geography. For example, even though a user might be physically located closer to one part of town, the user might prefer to go to the other side of town that is just as close or a little further away because it is easier to get to and/or a nicer part of the town. This scoping is used to determine exposure of an advertisement on different distribution channels. The scoping may include determining the appropriate breadth of a search input entered in Google that would trigger an advertisement. For example, with appropriate scoping a search for cardiologist in a rural area may trigger an advertisement for cardiologist in cities that are less than three hours drive away. A similar search for a cardiologist in a large city may trigger an advertisement for cardiologists in a specific section of the city.

The entire system discussed herein provides for territory-based automation of local sales teams. A local advertising system is provided that is based on automation of the local sales team. The system manages the local sales teams which operate in the territories described above. For example, a sales team in San Diego covers a certain territory, whereas a sales team in Los Angeles covers another territory. The system allows for the automation of managing the sales team, monitoring the sales numbers, and guiding the sales team.

Lead generation and sales campaign management is based on local business categories and historical local marketing data. Leads, i.e., the identities of businesses that are potential customers, are automatically generated for the sales team. The system provides for the management of a sales campaign, performing various tasks such as: (a) giving leads; (b) reviewing numbers to see how they are doing; (c) guiding sales people in terms of instructing them about whom to call, whom not to call, and helping with their follow ups; (d) helping with communication; and (e) monitoring their activities such as, for example, how many calls they made, how many re-lists of existing customers, what they did for their customers, how many free products they gave out, and what kind of sales activity has occurred.

The platform configurable advertising products and associations based on business categories, ROI and distribution channels. Advertising products may be created on-the-fly. A determination is made regarding the likely product category for the advertising product. A determination is made regarding profit margin, giving the client an idea of how many calls they need to get such as, for example, ten calls, from which two paying customers can be expected. A determination is made as to how many customers will be acquired from the phone calls, and how many calls they need before they get customers, how many people have to visit their website in order to get the right number of calls. A “reverse” calculation is made to help the system determine what kind of exposure a certain business will need in a certain area or geographical area.

The system also determines how many clicks (i.e., visits to the website) are required in order for a customer to get two times ROI, or some other multiple of the ROI. For example, if there needs to be 2000 clicks, and there is an advertising budget of $500 dollars, the system will determine what kind of distribution channels they need to use to produce 2000 clicks for $500. Configuring the distribution channels for the advertising product may be based on historical marketing data, the territory created, and the advertiser's ROI and the past performance of the channel.

The system automatically creates customer tracking web material and advertisement copies based on local business categories. For example, the system may have historical data for about 500 local categories.

The system provides automation of production and fulfillment of various advertising campaigns on various distribution channels. The advertising product is defined based on the ROI factors, and is sold by a sales person. The system knows the product was sold and that the particular advertising product should get a certain amount of exposure. The system also automatically tracks how the advertising product performed, and when the advertising product needs to be renewed and provides the sales team with a reminder.

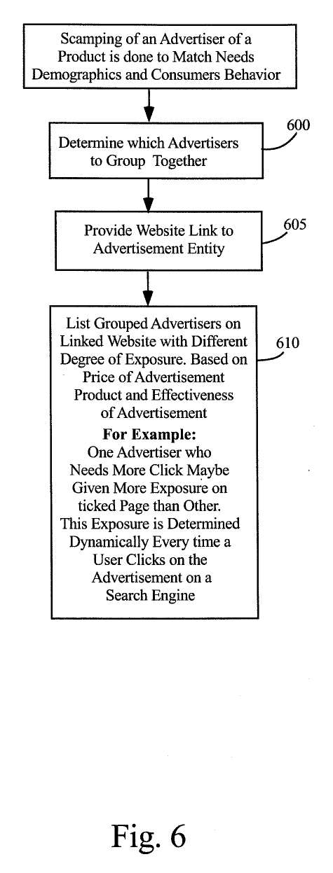

The system picks advertising products in an automated way. A pool of advertisers with similar criteria is grouped together for a better return on investment, while giving them individual exposure based on their budget and performance expectations, as discussed below with respect to FIG. 6. Multiple advertisers with similar products/services may also be grouped together, as well as advertisers with the same demographics for clients.

In the event that, for example, one law firm wants to spend $1,000, and another wants to spend $2,000, it may be advantageous to group the two together. One of the law firms might have a lower conversion rate and lower profit margin then the other. They are grouped together, and together they have $3,000 to advertise on the Internet, and more exposure is given to the law firm paying the larger amount.

Automated price adjustment may be performed based on local business criteria and performance calculations. Bidding optimization is performed for the advertising product to maximize the return on investment. The various factors in the particular category in the geographical area are identified and the expected performance is determined.

Automated, real time media distribution adjustment on various channels could be based on real time performance calculations. Configurable and real time adjustments in advertiser exposure on each channel are performed based on performance calculations and expectations. Proactive performance monitoring, alert mechanism and adjustment (for advertisers) is performed based on expected results, and advertising channels are managed. Franchisees (i.e., individual local sales teams) are monitoring and an analysis is performed based on performance expectation and calculations.

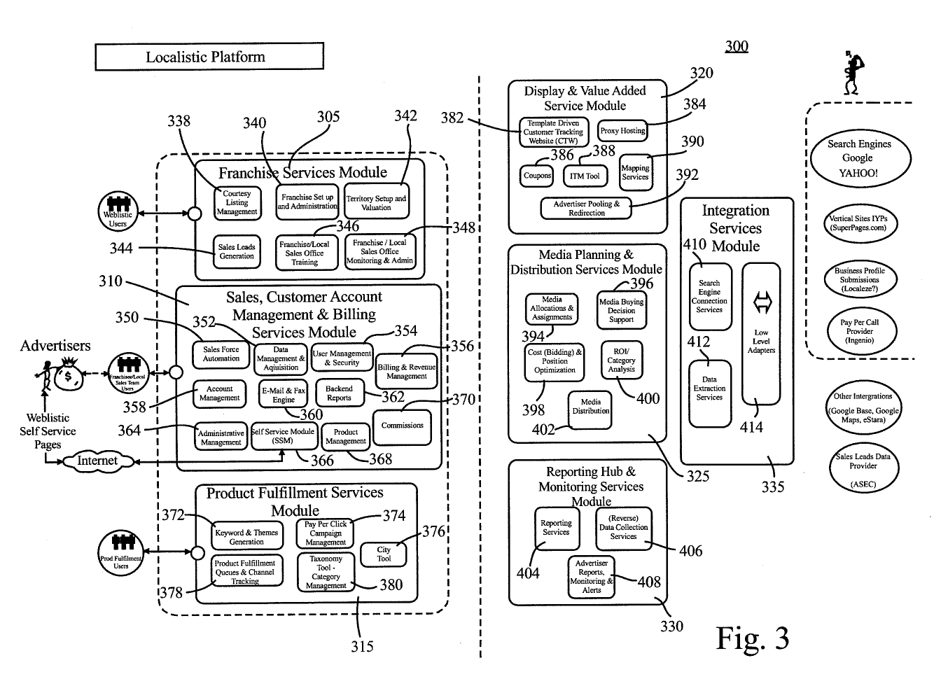

FIG. 3 illustrates a logistic platform 300 according to an embodiment of the invention. As illustrated, the logistic platform 300 includes several modules, such as a franchise services module 305; a sales, customer account management and billing service module 310; a product fulfillment services module 315; a display and value added services module 320; a media planning and distribution services module 325; a reporting hub and monitoring service module 330; and an integration services module 335. The franchise services module 305, the sales, customer account management and billing service module 310, and the product fulfillment services module 315 are collectively utilized for creating advertising products and managing functions of a sales force to sell such advertising sales products. The display and value added services module 320, the media planning and distribution services module 325, the reporting hub and monitoring service module 330, and the integration services module 335 are collectively utilized for product fulfillment.

The logistic platform 300 may be utilized to determine how much is typically spent on advertising in, for example, the Yellow Pages for each different category such as, for example, dentists, lawyers, and automotive.

The franchise service module 305 includes several submodules such as a courtesy listings management submodule 338, a franchise set up and administration submodule 340, a territory setup and valuation submodule 342, a sales leads generation submodule 344, a franchise/local sales office training submodule 346, and a franchise/local sales office monitoring and administration submodule 348. The various submodules are utilized for creating and managing a franchise.

As illustrated in FIG. 3, the sales, customer account management and billing service module 310 has several submodules of its own. As shown, the sales, customer account management and billing service module 310 includes a sales force automation submodule 350, a data management and acquisition submodule 352, a user management and security submodule 354, a billing and revenue management submodule 356, an account management submodule 358, an e-mail and fax engine submodule 360, a backend reports submodule 362, an administrative management submodule 364, a self service module (“SSM”) 366, a product management submodule 368, and a commissions submodule 370. These various submodules are utilized for managing sales of advertising products and managing customer accounts, billings and functions of sales people.

The product fulfillment services module 315 includes various submodules, including a keyword and themes generation submodule 372, a pay-per-click campaign management submodule 374, a city tool submodule 376, a product fulfillment queues and channel tracking submodule 378, and a taxonomy tool-category management submodule 380. These various submodules are utilized to ensure that an advertising product sold to a customer is being implemented as was promised to the customer and to automate the advertising fulfillment process.

The display and value added service module 320 includes various submodules, including a template driven tracking website (“CTW”) submodule 382, a proxy hosting submodule 384, a coupons submodule 386, a mapping services submodule 390, and an advertiser pooling and redirection submodule 392. The display and value added service module 320 is utilized to ensure that the advertising product is properly displayed and in the most valuable way.

The media planning and distribution services module 325 includes a media allocations and assignments submodule 394, a media buying decision support submodule 396, a cost (bidding) and position optimization submodule 398, a return on investment (“ROI”)/category analysis submodule 400, and a media distribution submodule 402. The media planning and distribution services module 325 ensures that advertisements are distributed on various channels based on their expected ROI. The media planning and distribution services module 325 thus evaluates the historic performance of advertisers, business categories and territories and adjusts distribution of media based on the evaluation. The media planning and distribution services module 325 also continually adapts to market fluctuations, on-going advertiser performance and actual return on investment calculations.

The reporting hub and monitoring service module 330 includes a reporting services submodule 404, a (reverse) data collection services submodule 406, and an advertiser reports, monitoring and alerts submodule 408. The reporting hub and monitoring service module 330 is utilized for reporting statistics for customers, advertising products, sales teams, business categories or channels.

The integration services module 335 is utilized for interfacing with various Internet search engines and other websites. The integration services module 335 includes a search engine connection services submodule 410, a data extraction services submodule 412, and a low-level adapter submodule 414. This module allows easy coupling of other modules with different channels.

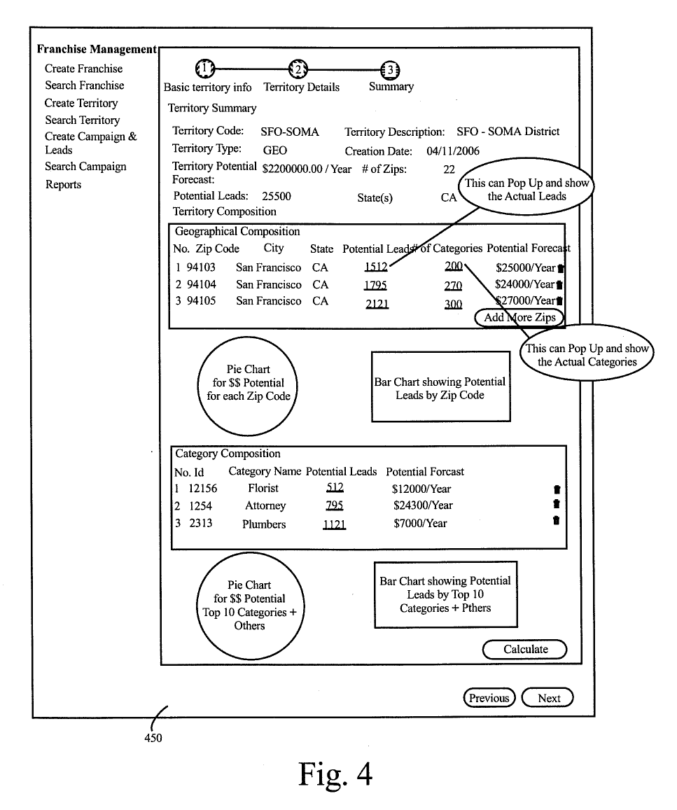

The logistic platform 300 described above with respect to FIG. 3 is utilized to generate various screens that are displayed to a sales person or other person monitoring the logistical platform via the user interface 220 shown in FIG. 2. FIG. 4 illustrates a territory creation display screen 450 shown on the user interface 220 according to an embodiment of the invention. The territory is determined based on the various characteristics of the surrounding areas and the types of businesses located nearby and the various demographics and other known relevant information about users within the area. As shown in FIG. 4, the data shown on the territory creation display screen 450 is for the SOMA area of San Francisco, with the code “SFO-SOMA.” The territory creation display screen 450 lists various information such as the date on which the territory was created, the potential revenue forecast for the territory, the number of potential leads (i.e., potential business advertising customers), the number of zip codes within the territory, as well as the name of the state in which the territory is located. Additional or alternative information may also be displayed. The territory creation display screen 450 may also list each individual zip code within the territory and may show hot links for the number of potential leads and number of business categories within each of the zip codes. By clicking on the hot links with, for example, a cursor that the user can manipulate via movement of a computer mouse, respective popup windows are displayed that list the individual leads and the individual categories, respectively. The territory creation display screen 450 may also display additional information such as a pie chart showing the revenue potential for each zip code and a bar chart showing the potential leads by zip code.

The territory creation display screen 450 may further display the various business categories. For example, there may be categories such as “Florist,” “Attorney,” and “Plumbers,” each with their own respective number of leads and potential revenue forecast. The territory creation display screen 450 may also display additional information such as a pie chart showing the revenue potential for the top ten or some other number of leads within business categories, and a bar chart showing the potential leads by the top 10 categories or some other number of the categories.

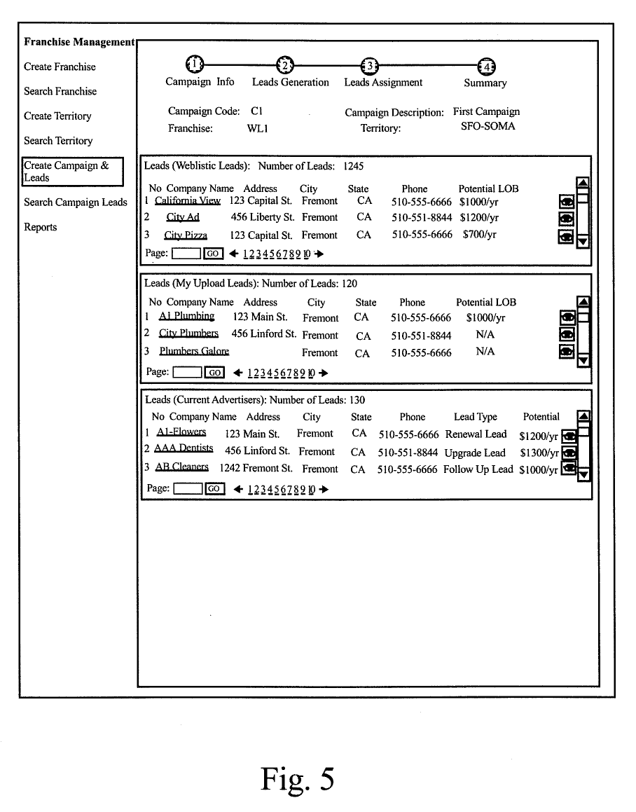

FIG. 5 illustrates a sales campaign and leads display screen 500 shown on the user interface 220 according to an embodiment of the invention. The campaign leads are determined based on the various characteristics of the surrounding areas and the types of businesses located nearby and the various demographics and other known relevant information about users within the area. As shown in FIG. 5, the data shown on the sales campaign and leads display screen 500 is for an area with the code “SFO-SOMA.” The sales campaign and leads display screen 500 lists information such as the contact information for potential leads, uploaded leads, salesperson generated leads and leads for current advertisers already using an advertisement product.

One of the features that may be provided to potential advertising customers is the pooling of similar businesses/products. For example, in the event that a dentist located in Beverly Hills, Calif. wants to advertise his business, it might not be cost-effective for the dentist to purchase an advertisement to advertise his own business. Instead, it may be more cost effective for a generic “Beverly Hills Dentist” advertisement to be displayed as an advertisement along with a link. By clicking on the link, the user is redirected to a website where various different dentists in the Beverly Hills, Calif. area are advertised. In the event that two different dentists have purchased advertising space, the dentist who purchased the more expensive advertising package may be displayed more prominently. Accordingly, such performance factors may be utilized in addition to the respective cost of the purchased advertising package to determine the order/prominence of the displayed links. In some embodiments, three or more links may be displayed on the grouped category page.

Bundling similar advertisements benefits not only the advertiser but it also benefits the consumer. The consumer is presented with consolidated content information regarding business and products. For example, a consumer accessing the Beverly Hills Dentist advertisement described previously does not need to explore multiple advertisements to choose a Beverly Hills dentist since the content is consolidated. The consumer can quickly determine if one of the dentists is in the consumer's neighborhood or if there is a dentist nearby that specializes in cosmetic dentistry.

FIG. 6 illustrates a method of grouping similar advertisers according to an embodiment of the invention. First, at operation 600, the system determines which advertisers to group together. Next, at operation 605, a website link is provided to the advertisement entity displaying the advertisement for the group of advertisers. The advertisement entity may be, for example, Google Adword™, Google Adsense™ or Yahoo Publisher Network™. Finally, at operation 610, the grouped advertisers are listed on the website linked to the advertisements with varying exposure based on the price of the purchased advertisement product, the effectiveness/performance factors for the advertisement and the number of clicks needed by an advertiser to meet ROI goals.

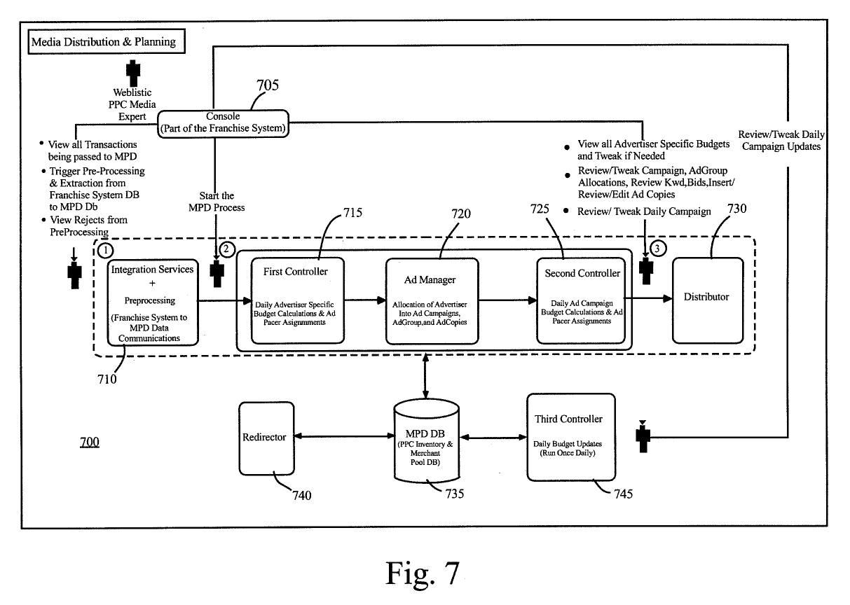

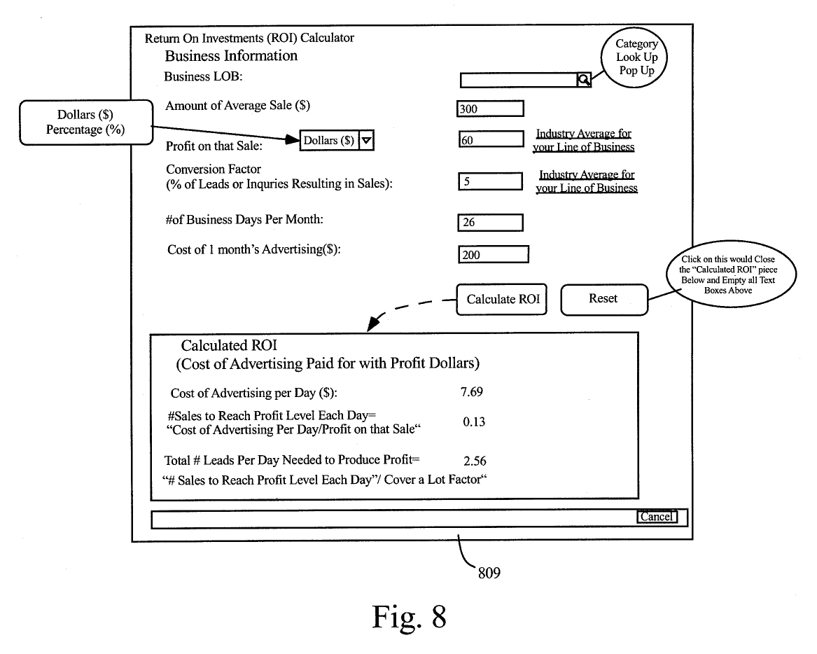

FIG. 7 illustrates an advertising management system 700 according to an embodiment of the invention. As shown, a console 705 is provided. The console 705 may be utilized by a sales person selling an advertising product and may include a user interface for displaying various leads and/or advertisement data. An integration services and preprocessing module 710 provides collects previous performance data from various channels and preprocess them to make further media placement decisions. A first controller 715 determines daily advertiser-specific budget calculations and advertisement pacer assignments to determine the pace of advertisement on various channels. Depending on performance; the pacer can accelerate, slow or pause an advertisement. An ad manager 720 allocates the advertiser into AdCampaign parameters such as campaigns, groups and content of advertisements. A second controller 725 determines the daily AdCampaign budget calculations and advertisement pacer assignments. The output of the second controller 725 is provided to a distributor 730, which provides relevant advertising information to various advertisement services, such as Google Adwords™ Google Adsense™ and Yahoo Publisher Network™.

A Media Planning and Distribution database 735 is in communication with the ad manager 720. The MPD database 735 contains a Pay-Per-Click Inventory and a merchant pool database. A redirector 740 is in communication with the MPD database 735. The redirector 735 determines which advertisement to show based on past performance and advertiser return on investment. A third controller 745 is also in communication with the MPD database 735. The third controller 745 runs daily budget updates.

The console 705, or the user interface 220 of FIG. 2, may also display an ROI calculator to a sales person. FIG. 8 illustrates a display screen 800 shown on the console 705, or the user interface 220 of FIG. 2, according to an embodiment of the invention. As shown, the display screen 800 lists various information, such as the business/customer line of business (“LOB”), the average sale amount, the profit in percentage or dollars, the conversion factor (i.e., the percentage of leads or inquiries resulting in sales of advertising products), the number of business days in the month, and the cost for one month's advertising.

The user may fill in or select the information mentioned above and then prompt the console 705 to calculate the ROI. The calculated ROI may list the cost of advertising per day, the number of sales required to reach a profit level each day, and the total number of leads per day needed to produce profit. This determines the number of click or calls required to meet the ROI.

Embodiments of the invention are directed to a complete local online advertising franchise platform. The local online advertising franchise platform is utilized to manage the selling of online advertising products, such as various online advertising packages of banner images, text or video advertisements. The platform determines a target geographical area and relevant business categories for a salesperson to pitch/offer the various online advertising products to various businesses with advertising needs. The platform manages sales people by generating leads for various businesses within a targeted geographical area and can help estimate the ROI of selling various advertising products to the leads.

The online advertising franchise platform provides for automated price adjustment based on local business criteria and performance calculations. It also provides for automated, real time media distribution adjustment on various channels based on real time performance calculations. Configurable and real time adjustment in advertiser exposure on each channel are based on performance calculations and expectations. Proactive performance monitoring, alert mechanism and adjustment (for advertisers) is provided based on expected results. The platform further manages various channels and monitors and analyzes franchisees (i.e., individual local sales teams) based on performance expectation and calculations.

The platform allows cohesive integration of various data points of hundreds of local business categories and uses them to create effective marketing campaign for a local business. The platform also automates and monitors functions of local sales force. The platform further provides ways to distribute, control and monitor advertisers exposure on various online channels. The platform also facilitates effective grouping of advertisers with similar goals and advertising criteria for giving them best possible return on their investment. The platform allows for the easy expansion of local sales forces through a franchise model.

This invention has been described in detail with reference to various embodiments. Not all features are required of all embodiments. It should also be appreciated that the specific embodiments described are merely illustrative of the principles underlying the inventive concept. It is therefore contemplated that various modifications of the disclosed embodiments will, without departing from the spirit and scope of the invention, be apparent to persons of ordinary skill in the art. Numerous modifications and variations could be made thereto by those skilled in the art without departing from the scope of the invention set forth in the claims.

What is claimed is:

1. A method of managing a sales person, comprising:
automating management of sales activities of the sales person selling an electronic advertisement product comprising:
defining a category for a business within a targeted geographical area;
defining a sales territory within the targeted geographical area;
creating the electronic advertisement product for the business based on the category and the sales territory; and
generating a lead for the sales person to sell the electronic advertisement product to the business within the sales territory.

2. The method of claim 1, wherein the automating management further comprises:
displaying an interactive user interface to the sales person for relaying performance and management activity information to the sales person and receiving sales activity related to online advertising products from the sales person.

3. The method of claim 1, wherein defining the category for the business is based on at least one parameter selected from a group of parameters consisting of, a type of business, a statistic generated from historic marketing data and an average amount spent on advertising.

4. The method of claim 1, wherein the defining the sales territory further comprises:
defining the targeted geographical area based on a predetermined revenue potential; and
increasing the targeted geographical area to include a plurality of businesses categorized into a plurality of categories in order to create a balance of businesses among the plurality of categories within the targeted geographical area.

5. The method of claim 4, wherein the automating management further comprises:
creating a plurality of electronic advertisement products for a portion of the plurality of businesses; and
generating a plurality of leads for the sales person to sell the plurality of electronic advertisement products.

6. The method of claim 5, wherein the creating the plurality of electronic advertisement products further comprises:
creating the plurality of electronic advertisement products by grouping the portion of the plurality of businesses having similar advertising interests for a better return on investment for each business while providing each business advertising exposure based on an individualized budget and performance expectations.

7. The method of claim 6, wherein the plurality of electronic advertisement products are based upon at least one of:
local demographics of the sales territory;
a local historical marketing data statistic for the plurality of businesses;
a local historical marketing data statistic for the plurality of categories;
available electronic distribution channels for advertisements by the plurality of businesses;
real time performance of each electronic advertisement product on each electronic distribution channel; and
performance expectations of the plurality of electronic advertisement products in each of the plurality of categories.

8. The method of claim 1, wherein the managing the sales activities of the sales person further comprises monitoring effectiveness of the sales person.

9. The method of claim 1, wherein the managing the sales activities of the sales person further comprises guiding the sales person in making a choice the choice being selected from a group of choices consisting of, choosing whom to call, choosing whom to not call, choosing whom to follow up with.

10. The method of claim 1, wherein the managing the sales activities of the sales person further comprises monitoring type and amount of efforts made by the sales person acting on the lead.

11. The method of claim 1, wherein the managing the sales activities of the sales person further comprises monitoring amount of re-listing done by the sales person.

12. The method of claim 1, wherein the managing the sales activities of the sales person further comprises monitoring how many free products given out by the sales person.

13. The method of claim 1, wherein the managing the sales activities of the sales person further comprises teaching the sales persons how to perform a sale of an electronic advertisement.

14. A system for managing a sales person, comprising:
an automating server configured to automate management of sales activities of the sales person selling an electronic advertisement product comprising:
a categorizing module coupled to the automating server, the categorizing module configured to define a category for a plurality of businesses located within a targeted geographical area;
a territory creation module coupled to the automating server, the territory creation module configured to define a sales territory within the targeted geographical area for the sales person;
the automating server further configured to create the electronic advertisement product for a business based on the category and the sales territory; and
the automating server further configured to generate leads for the sales person to sell the electronic advertisement product to the business within the sales territory.

15. The system of claim 14, further comprising:
a user interface module configured to display an interactive user interface to the sales person for relaying performance and management activity information to the sales person and receiving sales activity information from the sales person.

16. The system of claim 14, wherein the categorizing module is further configured to define the category for the plurality of businesses based on at least one parameter selected from a group of parameters consisting of, a type of business, a statistic generated from historic marketing data and an average amount spent on advertising.

17. The system of claim 14, wherein the territory creation module is further configured to define a geographical area comprising the business based on a predetermined revenue potential; and
the territory creation module is further configured to increase the geographical area to include the plurality of businesses categorized into a plurality of categories in order to create a balance of businesses among the plurality of categories within the geographical area.

18. The system of claim 17, wherein the automating server is further configured to create a plurality of electronic advertisement products for a portion of the plurality of businesses; and
the automating server is further configured to generate a plurality of leads for the sales person to sell the plurality of electronic advertisement products.

19. The system of claim 18, wherein the automating server is further configured to create the plurality of electronic advertisement products by grouping the portion of the plurality of businesses having similar advertising interests for a better return on investment for each business while providing each business advertising exposure based on an individual budget and performance expectations.

20. The system of claim 19, wherein the plurality of electronic advertisement products are based upon at least one of:
demographics of the sales territory;
a statistic of historical marketing data for the plurality of businesses;
a statistic of historical marketing data for the plurality of categories;
available electronic distribution channels for advertisements by the plurality of businesses;
real time performance of each electronic advertisement product on each distribution channel; and
performance expectations of the plurality of electronic advertising products in each of the plurality of categories.

21. The system of claim 14, wherein the automating server is further configured to manage the sales activities of the sales person in the sales territory by monitoring effectiveness of the sales person.

22. The system of claim 14, wherein the automating server is further configured to manage the sales activities of the sales person in the sales territory by guiding the sales person in making a choice the choice being selected from a group of choices consisting of, choosing whom to call, choosing whom to not call, choosing whom to follow up with.

23. The system of claim 14, wherein the automating server is further configured to manage the sales activities of the sales person in the sales territory by monitoring type and amount of efforts made by the sales person acting on a lead.

24. The system of claim 14, wherein the automating server is further configured to manage the sales activities of the sales person in the sales territory by monitoring amount of re-listing done by the sales person.

25. The system of claim 14, wherein the automating server is further configured to manage the sales activities of the sales person in the sales territory by monitoring how many free products are given out by the sales person.

26. The system of claim 14, wherein the automating server is further configured to manage the sales activities of the sales person in the sales territory by teaching the sales persons how to perform a sale.

27. A method of local online advertising, the method comprising the steps of:
creating a business category and a sales territory;
creating an advertisement for a business in the business category and the sales territory;
generating a sales lead for the advertisement;
selling the advertisement for a price;
bundling a plurality of advertisements into an advertising product; and
distributing the advertising product through a plurality of distribution channels.

28. The method of claim 27 further comprising the step of monitoring the advertising product and adjusting the price based on a performance calculation.

29. The method of claim 27 further comprising the step of monitoring the advertising product and adjusting exposure of the advertising product on each of the plurality of distribution channels.

30. The method of claim 27 further comprising the step of monitoring a performance parameter of the advertising product, the performance parameter selected from a group of parameters consisting of, an expected result of one of the plurality of advertisements, an expected results of the plurality of advertisements, a performance of one of the plurality of distribution channels and a performance of the plurality of distribution channels.

31. A media planning and distribution module recorded on a computer readable medium, the media planning and distribution module comprising:
a media allocation routine for allocating advertising media to a plurality of advertising channels;
a media buying routine for purchasing advertisements on the plurality of advertising channels;
a cost optimization routine for assessing a cost on each of the plurality of advertising channels;
a return on investment module for calculating the return from each of the plurality of advertising channels; and
a media distribution routine for distributing advertising media to the plurality of advertising channels.

32. A method of monitoring the performance of an advertiser, the steps of the method comprising:
estimating the performance of the advertiser;
evaluating market fluctuations;
analyzing an advertising budget and historic records of the advertiser; and
comparing the advertising budget with historic data for a business category and a territory.
